(19) United States
(12) Patent Application Publication
(10) Pub. No.: US 2018/0018619 A1
(43) Pub. Date: Jan. 18, 2018

(54) SYSTEM AND METHOD OF ARRANGING ITEMS IN A VEHICLE

(71) Applicant: Honda Motor Co., Ltd., Tokyo (JP)

(72) Inventor: Mark KISILER, Torrance, CA (US)

(21) Appl. No.: 15/212,486

(22) Filed: Jul. 18, 2016

(51) Int. Cl. G06Q 10/08; G01C 21/34; B60P 3/00

(52) U.S. Cl. CPC G06Q 10/083; B60P 3/007; G01C 21/3453

(57) ABSTRACT

The systems and methods provided herein are directed to identifying items to be loaded or unloaded into a vehicle, determining an arrangement of the items, and providing instructions for loading or unloading the items. The arrangement and a route may be generated based on one or more characteristics of the items and the location of the items. Instructions may be generated based on the arrangement and route.

### BACKGROUND

Companies have developed cargo applications allowing users to fit items into their vehicle. These applications, however, have drawbacks. For example, the applications fail to take into account stops at locations along a route. Such applications have not considered obtaining and delivering items along the route. The present disclosure provides a system and method thereof that addresses these concerns. Other benefits and advantages will become clear from the disclosure provided herein and those advantages provided above are for illustration.

### BRIEF DESCRIPTION

According to one exemplary embodiment, a system for arranging items in a vehicle having an available space is provided. The system may include an identification component receiving a first indication of a first item to be obtained and loaded into the available space at a first location, the first indication including at least one characteristic of the first item and a second indication of a second item to be obtained and loaded into the available space at a second location, the second indication including at least one characteristic of the second item. In addition, the system may include a storage optimization component determining an arrangement of the first and second items within the available space based on the at least one characteristic and the first location of the first item and the at least one characteristic and the second location of the second item. The system may also include an output component providing instructions for placing the first item and the second item in the available space according to the arrangement

According to another exemplary embodiment, a method for arranging items in a vehicle is provided. The method may include determining a space in the vehicle located at a starting location, receiving, at an identification component, a first indication of a first item to be loaded or unloaded into the space at a first location, the first indication including at least one characteristic of the first item, and receiving, at the identification component, a second indication of a second item to be loaded or unloaded into the space at a second location, the second indication including at least one characteristic of the second item. In addition, the method may include determining an arrangement of the first and second items within the space based on the at least one characteristic and the first location of the first item, the at least one characteristic and the second location of the second item and the space. The method may also include providing, on a display, instructions for placing or removing the first item and the second item in the space according to the arrangement

According to yet another exemplary embodiment, a computing device for arranging items is provided. The computing device may include a sensor analyzing and monitoring an available space in a vehicle and a storage optimization component. The storage optimization component may include receiving a first indication of a first item to be obtained and loaded into the available space at a first location, the first indication including at least one characteristic of the first item and a second indication of a second item to be obtained and loaded into the available space at a second location, the second indication including at least one characteristic of the second item. In addition, the storage optimization component may include calculating an optimal route from a starting location to the first location and the second location based on the at least one characteristic of the first item and the at least one characteristic of the second item, wherein the at least one characteristic of the first item is a time at which the first item has to be obtained and the at least one characteristic of the second item is a weight of the second item and determining an arrangement of the first item and second item within the available space, the arrangement being determined based on the optimal route, the at least one characteristic of the first item and the at least one characteristic of the second item. The storage optimization component may also include providing, on a display, instructions for routing to the first location, placing the first item in the available space according to the arrangement, routing to the second location, placing the second item in the available space according to the arrangement and routing to the starting location.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is an illustrative environment in accordance with one aspect of the present disclosure;

FIGS. 2A-2E are illustrative schematics showing exemplary components of a vehicle in various configurations in accordance with one aspect of the present disclosure;

FIG. 3 is an illustrative block diagram showing exemplary components of a computing device in accordance with one aspect of the present disclosure;

FIG. 4 is an illustrative block diagram showing exemplary components of a computing device in accordance with aspects of the present disclosure;

FIG. 5 is a flow chart showing an exemplary process for obtaining and loading items into a vehicle in accordance with one aspect of the present disclosure;

FIG. 6 is a flow chart showing another exemplary process for obtaining and loading items into a vehicle in accordance with aspects of the present disclosure;

FIG. 7 is a continuation of the flow chart in FIG. 6;

FIG. 8 is a continuation of the flow chart in FIG. 7;

FIG. 9 is a schematic view of an exemplary optimal arrangement of items in a vehicle in accordance with aspects of the present disclosure;

FIG. 10 is a schematic view of an exemplary optimal route in accordance with aspects of the present disclosure;

FIGS. 11A and 11B are illustrative arrangements for placing items in a vehicle in accordance with aspects of the present disclosure;

FIG. 12 is a flow chart showing exemplary processes for providing a load strategy in accordance with one aspect of the present disclosure;

FIG. 13 is an illustrative scenario for route planning in accordance with one aspect of the present disclosure;

FIG. 14 is a flow chart showing exemplary processes for determining whether adjustments should be made in accordance with one aspect of the present disclosure;

FIG. 15 is an illustrative system for detecting lost items in accordance with one aspect of the present disclosure; and

FIG. 16 is a flow chart showing exemplary processes to detect lost items in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The following includes definitions of selected terms employed herein. The definitions include various examples and/or forms of components that fall within the scope of a term and that may be used for implementation. The examples are not intended to be limiting.

A “bus,” as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a media oriented system transport network (MOST), a local area network (LAN), a wide area network (WAN), a point-to-point system, a circuit switching system, a packet switching system, among others.

A “component,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another component, method, and/or system. A component may also include logic, a software controlled microprocessor, a discrete logic circuit, an analog circuit, a digital circuit, a programmed logic device, a memory device containing executing instructions, logic gates, a combination of gates, and/or other circuit components. Multiple components may be combined into one component and single components may be distributed among multiple components.

A “processor,” as used herein, includes, but is not limited to a device that may process signals and perform general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various components to execute various functions.

A “memory,” as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory may store an operating system that controls or allocates resources of a computing device. Memory may be operatively coupled to the processor. The memory may store program instructions that may be executed by the processor.

A “disk,” as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM) or the media associated with such drives. The disk may store an operating system that controls or allocates resources of a computing device.

An “operable connection” or a connection by which entities are “operably connected” or “communicably connected,” as used herein, is one in which signals, physical communications, and/or logical communications may be sent and/or received. An operable connection may include a wireless interface, a physical interface, a data interface, and/or an electrical interface.

Generally described, the systems and methods provided herein are directed to identifying items to be loaded and unloaded into a vehicle, optimizing the arrangement of those items within the vehicle, and providing instructions for loading and unloading the items into the vehicle. An application on a computing device may be provided that details placement of items within a vehicle. Items to be obtained and/or delivered may be determined by the characteristics of those items. A route may be generated based on the arrangement and/or characteristics of the items. At each stop of the route, adjustments may be made to the vehicle, including rearrangements as well as automated vehicle changes resulting in different vehicle configurations and arrangements.

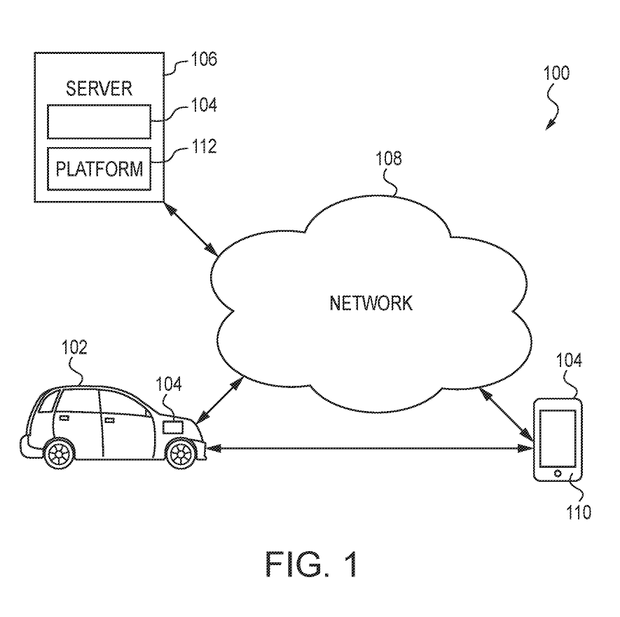

With reference to FIG. 1, an illustrative operating environment 100 in accordance with one aspect of the present disclosure is provided. The environment 100 may include a vehicle 102, a computing device 104 and a server 106. The vehicle 102, computing device 104 and/or server 106 may be communicatively connected with one another through a network 108 or through direct communications (e.g., the computing device 104 may be embedded within the vehicle 102 and interconnected to other vehicle systems through an in-vehicle network). The environment 100 may include fewer or more components and is not limited by those shown.

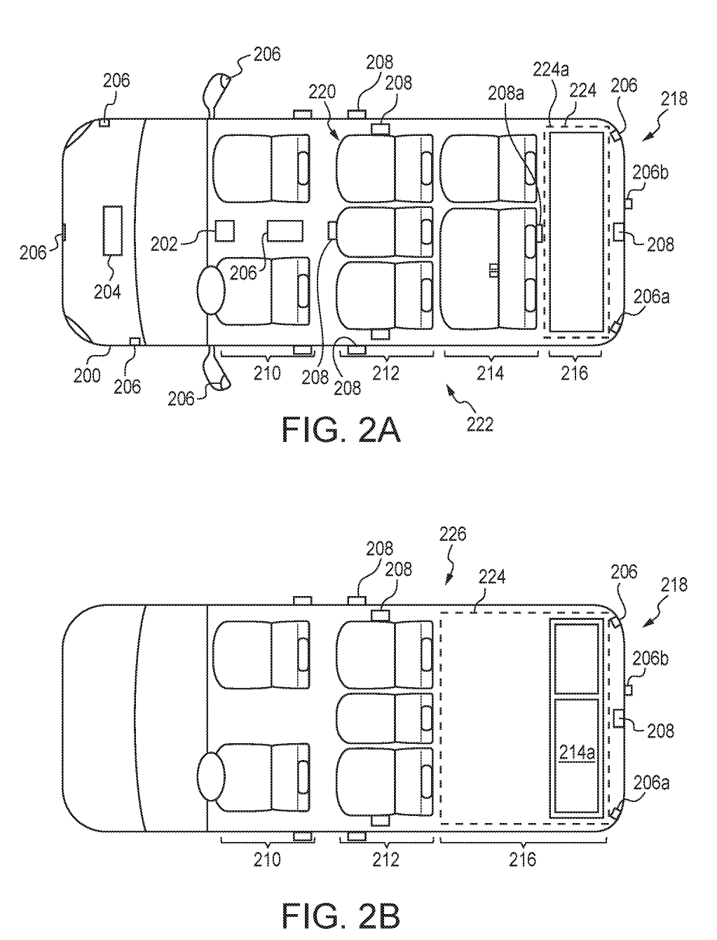

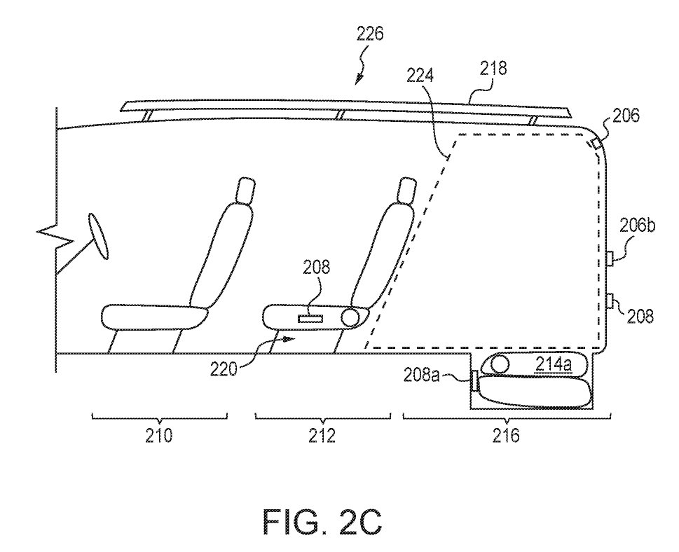

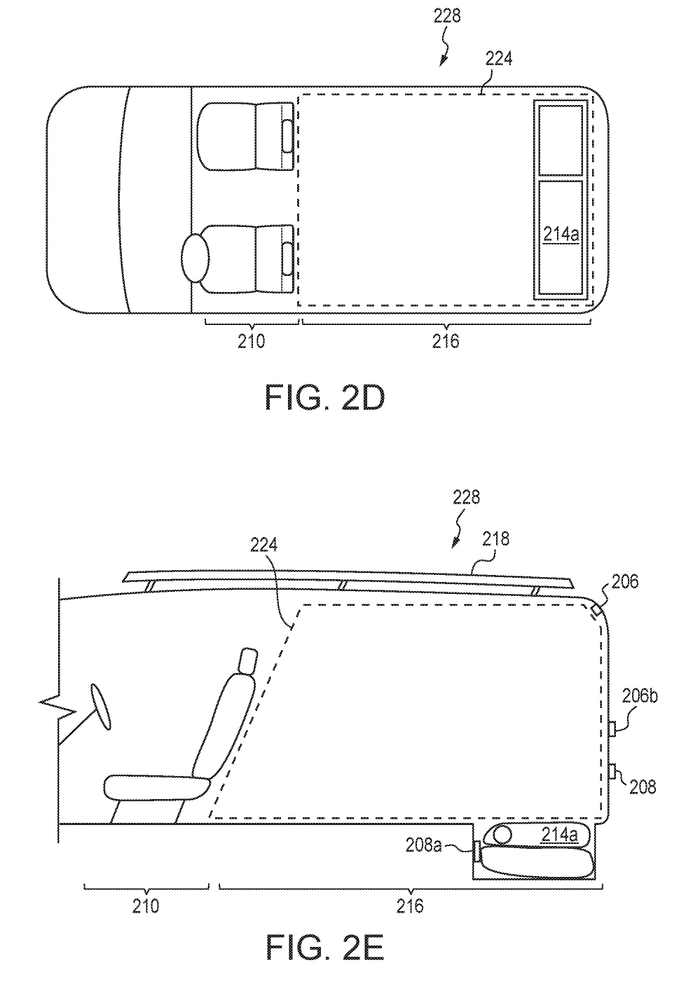

The vehicle 102 may be a motorcycle, car, truck, bus, airplane, boat or other similar transportation vehicle. The vehicle 102 may have many components and an exemplary vehicle will be described in further detail below with reference to FIG. 2.

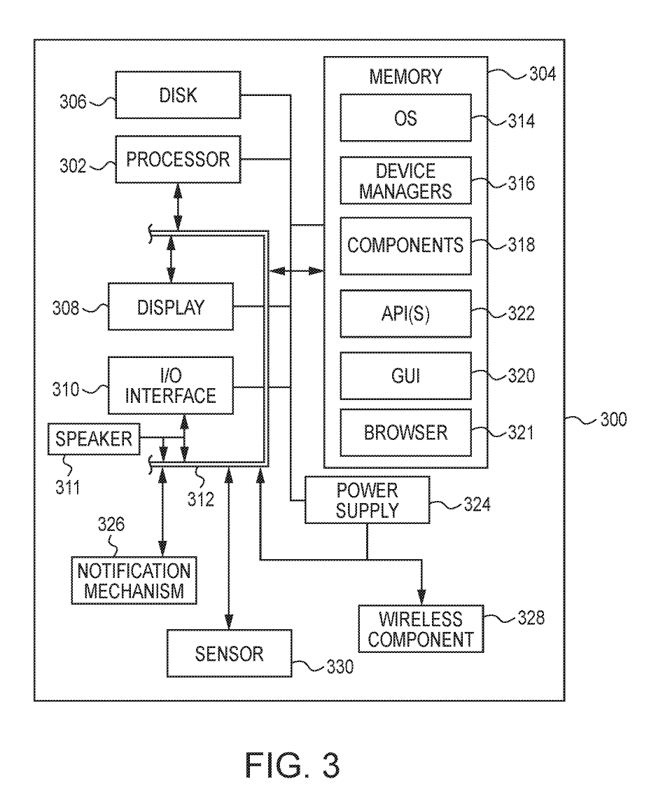

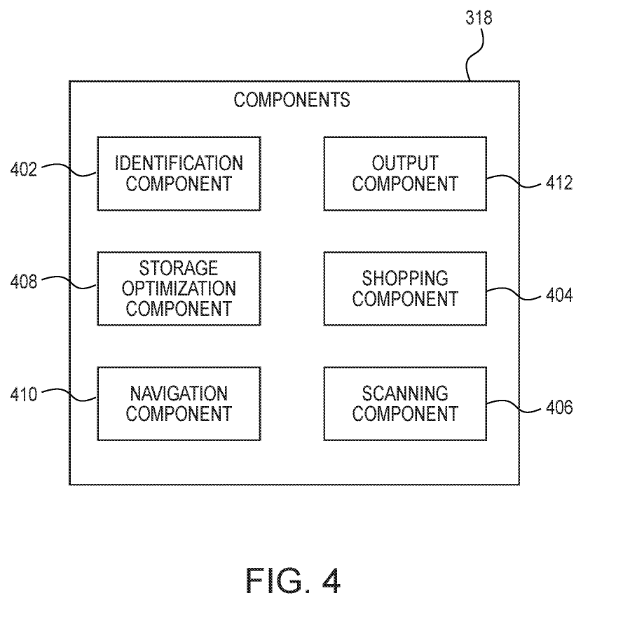

The computing device 104 may include or take the form of an embedded computing device within the vehicle 102 (such as a head unit, infotainment system, navigation system, etc.), a wireless enabled portable electronic device 110 such as a smartphone, a tablet computer, a mobile communications device, a notebook or laptop computer, a wearable computing device (e.g., in the form of glasses or a wristwatch), etc. The computing device 104 may include processing power to provide the systems described in more detail below. Alternatively, processing power and associated functions may be performed by the server 106, other systems within the vehicle 102, or a combination of any of the components within the environment 100. As shown in FIG. 1, the computing device 104 may be an integrated component in the vehicle 102, server 106, or portable electronic device 110. An exemplary computing device 104 will be described in further detail below with reference to FIG. 3.

The server 106 may host a platform 112. The platform 112 may take the form of a web service or network-based service that is accessible over at least an Internet protocol portion of a communications network 108. The platform 112 may support an application programming interface (API) through which other computing devices and/or software components (e.g., application programs or portions thereof) of the environment 100 may obtain information, post information, access information, initiate or receive commands, and/or communicate with or through platform 112.

The communications network 108 may include or take the form of one or more wired and/or wireless networks. The network 108 may include one or more wide area networks such as the Internet or a portion thereof, one or more cellular networks, one or more telephone networks, various intermediate networking devices, and edge devices such as wireless and/or wired access points, etc. Wireless access points may support the same or different wireless communications protocols. As one example, wireless access points may each support communications over wide-area cellular network protocols. As another example, wireless access point may support communications over a local-area network using the Wi-Fi protocol, while wireless access point may support communications over a wide-area cellular network.

Wireless communications between two or more devices within the environment 100 may take the form of short-range wireless communications link utilizing near-field communications or a personal area network via an RFID protocol, the Bluetooth wireless communication protocol, the Wi-Fi wireless communication protocol, or other suitable wireless communication protocol. As a non-limiting example, communication flow between an infotainment system of the vehicle 102 and portable electronic device 110 may take the form of short-range wireless communications over a near-field communication link and/or personal area network using one or more of RFID, Bluetooth, and/or Wi-Fi communication protocols. Alternatively or additionally, communication may take the form of a direct wired communications between the infotainment system and portable electronic device 110.

In addition, wireless communications between the components of the environment 100 may be provided over a local area network and/or a wide area network using other suitable protocols, and may traverse one or more intermediate networking devices and/or access points. For example, wireless links may utilize GSM, 3G UMTS/3GPP and/or 4G LTE/3GPP cellular protocols, Wi-Fi 802.11 protocols as defined by IEEE, Wi-Max 802.16 protocols as defined by IEEE, or other suitable wireless communication protocols. For example, communication flows in association with the communications network 108 may take the form of relatively long-range wireless communications using one or more of these wireless communication protocols.

FIG. 2A is a schematic view showing exemplary components of a vehicle 200 in accordance with one aspect of the present disclosure. Generally, the vehicle 200 may include a computing device 202. The computing device 202 may be a head unit, navigation unit, infotainment system or the like. The computing device 202 may be operably connected for computer communication to one or more vehicle systems 204. Vehicle systems 204 may include, but are not limited to, any automatic or manual systems that may be used to enhance the vehicle, such as, for driving, convenience and/or safety. The vehicle systems 204 may include and/or are operably connected for computer communication to various sensors 206. The sensors 206 may provide and/or sense information associated with the vehicle 200 and/or the surrounding vehicle environment. In one exemplary embodiment, the sensor 206 could be in communication with or be a part of the computing device 202.

The sensors 206 may include, but are not limited to, vehicle state sensors, vehicle system state sensors, proximity sensors, vision sensors, audio sensors, motion sensors, and other sensors. The sensors 206 may take the form of cameras, lasers, LIDAR, RADAR, infrared sensors, pressure sensors, ultrasonic sensors, humidity sensors, motion sensors, acceleration sensors, displacement sensors or color sensors. The sensors 206 may also include global positioning system (GPS) sensors, inertial measurement unit sensors (IMU), among other position and motion sensors. Other sensors may include, but are not limited to, vehicle speed sensors, accelerator pedal sensors, brake sensors, acceleration sensors, throttle position sensors, wheel sensors, anti-lock brake sensors, camshaft sensors, among others. Sensors 206 may also include seat position sensors and interior sensors. The sensors 206 may be disposed in the interior and/or on the exterior of the vehicle 200.

The vehicle sensors 206 may be operable to sense a measurement of data associated with the vehicle 200, vehicle components, the vehicle environment, the outside environment and/or occupants of the vehicle 200. The sensors 206 may generate data signals indicating the measurement of data. These data signals may be converted into other data formats (e.g., numerical) and/or used by the vehicle systems 204 and/or the computing device 202 to generate other data metrics and parameters. In one embodiment, the computing device 202 and components thereof may access and/or receive data (e.g., vehicle data, user data and other data) from the vehicle systems 204 and/or the sensors 206. As shown in FIG. 2A, the sensors 206 may be placed in many locations within or on the vehicle 200. The location of each sensor 206 may be determined based on the type of vehicle, the type of sensor and the purpose of the sensor. In one exemplary embodiment, sensor 206a may be positioned on the interior roof and angled down so as to be in view of a storage area of the vehicle. In another exemplary embodiment, sensor 206b may be positioned on the tailgate of the vehicle to be able to sense an exterior area of the vehicle 200.

The vehicle systems 204 may also include and/or be operably connected to one or more actuators 208. The actuators 208 may control many different mechanisms or systems on the vehicle 200. The actuators 208 may include motors, switches, latches, or other components that may be used to adjust the positioning or function of devices within the vehicle. The actuators 208 may be powered by electric current, hydraulic or fluid pressure, or pneumatic pressure. The actuators 208 may be activated by a control system which may be a mechanical or electronic system. The actuators 208 may be controlled by the computing device 202, vehicle systems 204, a human or any other input.

Continuing to refer to FIG. 2A, the vehicle 200 may be any type of vehicle. For example, the vehicle 200 may be a van type vehicle having a front seating area 210, a middle seating area 212, a rear seating area 214, one or more interior storage areas 216 and one or more exterior storage areas 218. Some vehicles may also include under-seat storage areas 220 in the front, middle or rear seating areas. The seating areas 210, 212 and 214 and/or storage areas 216, 218, 220 within the vehicle 200 may be configurable. For example, in a first configuration 222 illustrated in FIG. 2A, all seats within all seating areas 210, 212, 214 may be positioned for receiving passengers. This configuration 222 may leave only storage area 216 as an available space 224 for receiving items (non-passengers). In a second configuration 226 illustrated in FIGS. 2B and 2C, all seats in the middle seating area 212 may be positioned to receive passengers while one or all of the seats in the rear seating area 214 may be stowed. This configuration 226 may allow the front seating area 210 and middle seating area 212 to receive passengers while the rear seating area 214 and storage area 216 are open for receiving items in available space 224. In a third configuration 228 illustrated in FIGS. 2D and 2E, all seats in the middle seating area 212 may be removed and all seats in the rear seating area 214 may be stowed. This configuration 228 may allow the middle seating area 212, rear seating area 214 and storage area 216 to be an available space 224 for receiving items. Many similar configurations may be possible. For example, within each seating area 210, 212, 214, one or two of the two or three seats may be stowed or folded. In addition, the seats themselves in their normal positions may be considered storage areas 216. For example, in a sedan type vehicle, the rear seating area 212 may also be a storage area 218 and therefore an available space 224. These configurations may be established through the use of actuators 208. For example, actuator 208a may be activated in order to stow seat 214a.

Other vehicle types may include sedan type vehicles, coupe type vehicles, sport utility type vehicles, and light and heavy duty truck type vehicles. As described with the van-type vehicle example, the vehicle 200 may include interior storage areas 216 and exterior storage areas 218. The interior storage areas 216 may include areas such as a trunk and/or a passthrough between the trunk and a rear seating area in a sedan or coupe type vehicle, a rear storage area in a sport utility type vehicle or a van type vehicle, or in areas occupied by seats in a normal configuration but where the seats are removed or stowed in alternative configurations. Exterior storage areas 218 may include a roof, roof rack, roof mounted storage area, rear mounted storage area or an open truck bed in a truck type vehicle. These storage areas 216, 218 may be considered an available space 224 for receiving items. Each configuration of each type of vehicle may have a different available space 224 and each configuration may have different dimensions, thus having different capacities for receiving items. Each vehicle type or vehicle may also include a maximum capacity. This capacity may be by size, such as the maximum available space to receive items within and on the vehicle 200, or by weight, such as the gross axle weight capacity of the vehicle.

FIG. 3 is an illustrative block diagram showing exemplary components of a computing device 300 in accordance with one aspect of the present disclosure. The computing device 300 may include a processor 302 for implementing logic, a memory 304, a disk 306, a display 308 and an input/output (I/O) interface 310, each of which may be operably connected for computer communication via a bus 312 and/or other wired and wireless technologies. Fewer or more components may be provided with the computing device 300.

The I/O interface 310 may provide software and hardware to facilitate data input and output between the computing device 300 and other components including the server 106 and network 108. The display 308 of the computing device 300 may be a liquid crystal display (LCD), or any other type of display commonly used. The display 308 may be touch-sensitive, and may act as an input device.

The memory 304 generally includes both volatile memory (e.g., RAM) and non-volatile memory (e.g., ROM, Flash Memory, or the like). The non-volatile portion of the memory 304 may be used to store persistent information which should not be lost when the computing device 300 is powered down. The computing device 300 may include an operating system (OS) 314, such as the iOS operating system available from Apple Inc., the Android® operating system available from Google Inc., the Windows operating system available from Microsoft Corporation, or any other similar OS. The OS may reside in the memory 304 and be executed on the processor 302.

The memory 304 may also include one or more device managers 316 for interacting with one or more I/O devices. The device managers 316 may be software installed on the computing device 300. A device manager 316 may correspond to each I/O device. In addition to the device manager 316, one or more components 318 may be included or installed on the computing device 300. Generally, the components 318 may be used to identify items to be obtained and/or delivered, including determining the characteristics of items, determining available space on or in the vehicle, determining one or more routes for obtaining and/or delivering items and providing instructions for loading items on the vehicle. The components 318 may be provided through a graphical user interface (GUI) 320 that may be supported by the OS 314 or alternatively, as a separate component as shown. Further details of the components 318 will be described below with reference to FIG. 4. The memory 304 and operating system 314 may also include a browser 321. The browser 321 may be used through the GUI to view webpages or applications. The browser 321 may be any browser known in the art, such as the Chrome® browser available from Google Inc. Any of the software described above or below may be installed on the computing device 300 through a network connection 108 or via a direct link. Alternatively, the software may be preinstalled and may be part of the OS 314 or other application.

The memory 304 may also include a collection of one or more APIs 322 for facilitating wireless communication between the computing device 300 and one or more remote I/O devices. The APIs 322 may be invoked by the applications to recognize and control the one or more remote I/O devices. In this manner, the computing device 300 is able to take advantage of services or functionalities of the one or more remote I/O devices.

The computing device 300 may also include a power supply 324, which may be implemented as one or more batteries, fuel cells, or other sources of electrical power. The power supply 324 might further include an external power source, such as an AC adapter or a powered docking cradle that supplements or recharges the batteries for embodiments where the computing device 300 is embodied in a portable electronic device 110. The computing device 300 may also include one or more audio, visual, and/or vibratory notification mechanisms 326. These notification mechanisms 326 may be directly coupled to the power supply 324 so that when activated, they remain on for a duration dictated by the notification mechanism 326 even though the processor 302 and other components might shut down to conserve energy.

The computing device 300 may also include a wireless communication component 328, such as a Bluetooth component, Wi-Fi component or cellular communication component that facilitates wireless connectivity between the computing device 300 and other devices. The computing device 300 may also include a sensor 330 for receiving and/or capturing information about items to be obtained and loaded into the vehicle 200. The sensor 330 may be included in the computing device 300 when embodied as a portable electronic device 110 or the sensor 330 may be implemented separate from the computing device 300 as a sensor 206 as shown in FIG. 2A. It should be apparent that the functions described below for sensor 330 could equally apply to sensors 206.

In one exemplary embodiment, the sensor 330 may be a camera. Video may also be captured through the sensor 330. An LED source, not shown, may be provided with the sensor 330 which may provide near-instantaneous flash. The LED source may be connected to the power supply 324. The flash, for example, may be used for illuminating the environment around the computing device 300 or around the vehicle 200. Images may be saved in a variety of formats. Images from the sensor 330 may be processed automatically by adjusting for focus, for example, objects may be identified within the image and the objects may be focused on. Automatic zoom features may also be included on the sensor 330. These features may be software or hardware based, or a combination of both.

The software described above and below may be installed and executed on the computing device 300. As stated in reference to FIG. 1, the computing device 104 may be an integrated component in the vehicle 102, server 106, portable electronic device 110 or any combination thereof. For example, in one embodiment, the computing device 300 may run the software alone. The computing device 300 may be used to take images with its sensor 330. An available space 224 may be determined by the computing device 300 through its sensor 330 or through another method presented below. Processing may be performed through the processor 302 of the computing device 300, which may include identifying items to be obtained and/or delivered, including determining the characteristics of items, determining available space on the vehicle, determining one or more routes for obtaining and/or delivering items and providing instructions for loading items on the vehicle. Alternatively, the software may be installed and executed on a computing device 300 embedded in a vehicle 200. Sensors 206 may be able to determine information within the vehicle 200 regarding an available space 224 and items outside the vehicle 200. Sensors 206, including cameras, may be able to capture the information as described above. Processing on the computing device 300 may be performed by its processor 302 whereby an available space 224 is determined along with characteristics of items to be placed into the vehicle 200. Arrangements as well as routes may then be generated by the computing device 300.

Additionally, the server 106 may include the computing device 300 and software which may be used to generate optimal cargo arrangements. Information may be provided through portable electronic device 110 or through the sensors 206 on the vehicle 200 and sent to the server 106 for processing remotely. Information, for example, may be maintained locally on the server 106 such as available space 224 within the vehicle 200. Information related to an available space 224 may be sent from the vehicle 200 to the server 106. This information may be processed or not processed, for example, a raw image of the interior may be sent to the server 106. Item information may be sent by the computing device 300 or portable electronic device 110. Optimal arrangements may be made on the server 106 and then provided back to the vehicle 102 and/or the computing device 300.

FIG. 4 illustrates a block diagram of exemplary components 318 that may be installed and executed on the computing device 300, as described above, for carrying out various functions. In one exemplary embodiment, the computing device 300 may include an identification component 402, a shopping component 404, a scanning component 406, a storage optimization component 408, a navigation component 410 and an output component 412. Other additional components are possible. Not all components 318 described herein are required and the functionality described herein may be shared amongst the components 318 or performed by other components 318.

In one exemplary embodiment, the identification component 402 may be responsible for identifying items that are to be obtained and loaded into the vehicle 200. The items identified may be at a location remote from the vehicle or they could be co-located with the vehicle but not yet loaded into the vehicle. Alternatively, the items identified may already be loaded into the vehicle. These items may need to be delivered to a location rather than obtained from a location. Any combination of these scenarios is possible. For example, some items may already be loaded into the vehicle located at a first or starting location, for example, the user's home. Some items may be co-located with the vehicle but not yet loaded into it. Additional items may need to be obtained at a second location and loaded into the vehicle. Finally, the items already loaded into the vehicle may need to be unloaded and delivered to a third location different from the first and second locations.

The identification component 402 may identify the items by receiving an indication of each item. The indication may include information about the item that enables the identification component 402 to determine the identity of the item. The indication may include text data, voice data, sound data, image data, and/or video data. For example, the indication may be a title of an item. The title may be stored in a database in the identification component 402 and the identity of the item determined through a look-up table in the database. In another example, the indication may also be an image. Image processing and recognition may be used to determine the identity of the image and the item. Any data may be used to indicate any type and any number of items. A non-exhaustive and non-limiting list of possible items may include people, pets, bags, boxes, packages, suitcases, buckets, tables, chairs, couches, beds, other furniture, clothes, groceries, child safety seats, strollers, sporting goods, etc.

The identification component 402 may also determine one or more characteristics about the items. The characteristics may be determined from the indication received about each item. As discussed above, the indication may include text data, voice data, sound data, image data, and/or video data. For example, the indication may include the dimensions and weight of the item. In another example, the dimensions may be calculated by analyzing image data received as part of the indication of the item. In yet another example, the identification component 402 may include a database of characteristics of many items. The indication may allow the identification component 402 to identify the characteristics of the item through a look-up table in the database. Any data may be used to indicate any characteristic of any item. A non-exhaustive and non-limiting list of possible characteristics of items may include dimensions, weight, shape, limitations on direction of placement (“This Side Up”), the location of the item, the time the item must be picked up or delivered, the type of materials, whether the item is stackable, perishable, soft, hard, bendable, etc.

The identification component 402 may receive the indication in the form of manual input from a user. The manual input may be received from the display 308, I/O interface 310, GUI 320, browser 321, APIs 322 and/or any other component 318. For example, the user may input the number and type of grocery bags and larger grocery items to be obtained from a plurality of grocery stores and loaded into the vehicle 200. In another exemplary embodiment, the identification component 402 may have a listing of possible items to be obtained and loaded into the vehicle 200 and the user may manually select those items from the list. A GUI 320 may be provided such that those items may be manually entered in. Characteristics of the items may also be entered. In one embodiment, prompts may be used for entering in information about the items.

The identification component 402 may also receive one or more indications of items to be obtained and loaded into the vehicle 200 from the shopping component 404. In one exemplary embodiment, the shopping component 404 may be one of the components 318 of the computing device 300. In another exemplary embodiment, the shopping component 404 may be located remote from the computing device 300, such as at the server 106 or at another server or computer remote from the environment 100. In one exemplary embodiment, the shopping component 404 may take the form of a website or application. The user may use the shopping component 404 to execute a search for items available for purchase. The user may select one or more items and the shopping component 404 may send indications of the items to the identification component 402. The indications may include names and characteristics of the items. The shopping component 404 may also determine the most appropriate location to obtain the item. For example, the shopping component 404 may complete a search on the Internet to determine the store that has a certain type of item or certain model. The determination may be made based on price of the item at the store and the distance to the store from the user's home. The items selected from searches executed by the shopping component 404 may be saved and stored in memory 304. On subsequent occasions, the stored items may be selected by the user and an indication may be sent to the identification component 402.

The identification component 402 may include text analysis capabilities in order to derive characteristics of items from textual descriptions of the items. For example, the shopping component 404 may include a detailed description or technical specification of each item. The identification component 402 may execute a text analysis of the description and identify specific keywords or phrases that indicate particular characteristics of each item. For example, if the description includes keywords such as, pounds, ounces, grams, inches, feet, centimeters, etc., the identification component 402 may extract the keywords and any numbers associated with the keywords as characteristics of the items. For example, seven pounds, 24 ounces, 400 grams, 30 inches, three feet, 52 centimeters, etc. may be considered characteristics. Other keywords may not be associated with numbers and may just be descriptive of the item. For example, other non-numerical characteristics may include but are not limited to, square, rectangular, cylindrical, fragile, “this side up,” perishable, etc. Any known text analysis techniques may be used. It should be apparent that the text analysis may be provided by the shopping component 404 rather than the identification component 402.

The identification component 402 may also receive one or more indications of an item from the scanning component 406. The scanning component 406 may analyze the items or information about the items in order to assist the identification component 402 in determining identity of the items and/or characteristics about the items. The scanning component 406 may detect information about the items themselves. For example, the scanning component 406 may receive an image of the item. The scanning component 406 may also detect information associated with the items, such as a bar code. In addition, the scanning component 406 may observe the items to detect information about the items, for example, analyzing video of the items as they are being loaded into the vehicle 200 or by monitoring the items after they are loaded into the vehicle 200. In one exemplary embodiment, the scanning component 406 may be communicatively coupled to one or more sensors 206. The scanning component 406 may receive information from the sensors 206 and using that information, determine one or more of the items and/or determine one or more characteristics about each of the items. The sensors 206 may capture any data related to the items. The data may include text data, voice data, sound data, image data, and/or video data. The scanning component 406 may determine characteristics of the items based on the data captured by the sensors 206. As described above, it should be apparent that the sensors 206 could be part of the vehicle 200, as shown in FIG. 2A, or part of the computing device 300, such as sensor 330, as shown in FIG. 3.

In one exemplary embodiment, the scanning component 406 may include machine vision capabilities. Machine vision capabilities may include methods for acquiring, analyzing, and understanding images in order to produce data from the images. Machine vision examples include: image processing, object recognition, object comparison, object measurement (metrology), identification, optical character recognition, bar code reading, motion analysis, motion tracking, scene recognition, pattern recognition and other similar machine vision techniques. In one exemplary embodiment, the scanning component 406 may use one or more of these techniques in combination with the data received from one or more of the sensors 206 to identify the items and/or characteristics of the items to be obtained and loaded into the vehicle 200.

In another exemplary embodiment, the sensors 206 may be used to scan an area in front of or around the vehicle 200 for items to be placed therein. Characteristics of the items may be detected automatically, for example, the scanning component 406 may predict that a large item is surrounded by smaller items. Known box shapes may be used to determine whether some items are in front of other items. In one exemplary embodiment, the size of the items may be determined through image comparisons. Background images may be used to determine the size of the items. For example, a sidewalk curb may be identified and compared with the items to determine their size. Other known objects may be compared such as size of a normal person, mailbox, vehicle, etc. Size determinations may be made when a user places a known object within the image, for example, a quarter or a user's hand.

In one exemplary embodiment, as described above, the computing device 300 may be separate from the vehicle 200. A user, through their portable electronic device 110, may capture images of the items to be placed into the vehicle 200. The user may take a picture of the items, similar to the on-vehicle sensors 206, and the scanning component 406 may determine those items to be placed in the vehicle 200. The picture may be analyzed by the scanning component 406 on the portable electronic device 110, the computing device 300 located on the vehicle 200 or the server 106, which may determine the items and characteristics of them for loading into the vehicle 200.

In one exemplary embodiment, the pictures may be analyzed by matching items within the picture to known objects. Machine learning techniques may be used. A number of training images may be processed and evaluated. Using those training images and matching them with those objects found in the picture, the item may be properly identified. Scene recognition may be used to determine what type of item the user wishes to place into the vehicle 200. For example, if the user is at a park, the item to be placed into the vehicle 200 may more likely be related to picnic items rather than clothing items. In another example, items at the beach are unlikely to be the same items at the grocery store. The items do not have to be exactly determined. In one embodiment, the general outline or shape of the item may be determined.

In another exemplary embodiment, an item for possible loading into a vehicle 200 may be scanned. A sensor 330 on the portable electronic device 110 may capture an image of a bar code, such as a UPC, QR code, or the like. Alternatively, a wholly dedicated device may be used to scan the code. The code may be scanned and processed locally by scanning component 406 on the portable electronic device 110. The code may alternatively be processed by the scanning component 406 on the computing device 300 located at the vehicle 200, server 106 or a combination of the components of the environment 100. The sensor 330 on the portable electronic device 110 may allow the user to take images far away from the vehicle 200 and identify the item to be obtained and loaded into the vehicle 200.

In yet another exemplary embodiment, the scanning component 406 may include motion tracking capabilities. Using video data, consecutive frames of image data or similar data, the scanning component 406 may detect and identify an item to be obtained and loaded into the vehicle 200. Once the item is identified, the scanning component 406 may track the item in the data (e.g. from frame to frame in video data) using any motion tracking capabilities known in the art. Tracking the item in the data may mean determining whether the item changes shape from one frame to the next. The scanning component 406 may track the item to determine whether or not the shape of the item changes as it moves. For example, a bag of groceries may initially have a rectangular shape but as it is moved to load into the vehicle 200, the shape may change. The scanning component 406 may use this data to determine that the bag is softer than originally identified and may provide that information to the identification component 402. Motion tracking may also be used to monitor items once they are loaded into the vehicle 200 as will be discussed in more detail below.

Continuing to refer to FIG. 4, the storage optimization component 408 may be responsible for determining how to arrange the items that have been identified by the identification component 402. This may include determining the possible configurations of the vehicle seating areas and storage areas that may be used for receiving the items into the vehicle 200. It may also include determining the available space in those possible configurations and determining a selected configuration that may be used for an optimal arrangement of the items in the available space. The optimal arrangement may be the configuration and arrangement that violates a minimum number of arrangement rules or meets a predetermined threshold of the arrangement rules.

In one exemplary embodiment, the possible configurations and the available space within those configurations could be stored within the computing device 300 and accessed by the storage optimization component 408. In another exemplary embodiment, the configurations and available space could be stored on the computing device 300 at the vehicle 200 and shared with the storage optimization component 408 in the computing device 300 at the portable electronic device 110 or server 106. The information that may be stored about the configurations and available space may include the shape of the space, the size, dimensions, and other characteristics of the space, the dimensions of the floor of the space, among others.

The storage optimization component 408 may also determine the available space 224 in the vehicle 200 through one or more sensors 206. As discussed above with reference to FIG. 2A, the sensors 206 may include, vision sensors, such as cameras or infrared sensors, ultrasonic sensors, motion sensors, seat position sensors and the like. The sensors 206 may be disposed in the interior and/or on the exterior of the vehicle 200. In one exemplary embodiment, the sensor 206a may be a camera positioned on the interior of the roof of the vehicle focused on the seating areas 210, 212, 214 and storage areas 216, 218, 220 of the vehicle interior. In another exemplary embodiment, the sensor 206a may be an ultrasonic sensor or other a similar sensor. In a further exemplary embodiment, the sensor may be positioned on the exterior of the roof of a truck type vehicle and focused on a truck bed.

The sensors 206 may provide data to the storage optimization component 408. Using the data, the storage optimization component 408 may calculate the amount of available space 224 within the vehicle 200 in its current configuration. Alternatively, the sensors 206 may calculate the amount of available space 224. Any method known in the art may be used. For example, using the sensor 206a and one or more of the machine vision methods discussed above, the storage optimization component 408 may determine the dimensions of the available space 224 of the vehicle 200. In addition, one or more actuators 208 may be activated automatically to change configurations within the vehicle 200. The storage optimization component 408 may then determine the amount of available space 224 in additional configurations. For example and as shown in FIGS. 2A and 2C, sensor 206a may calculate the amount of available space 224a in the first configuration 222. Actuator 208a may then be activated to move seat 214a to the stowed position in the second configuration 226. Sensor 206a may then calculate the amount of available space 224b in the second configuration. The storage optimization component 408 may then compare the available space 224a to the available space 224b to determine which configuration to select.

In one exemplary embodiment, the sensors 206 may be activated when a signal is sent from the computing device 300 to the sensors 206 requesting the amount of available space 224. The signal may “wake up” the sensors 206, or other applicable systems. In one embodiment, activation of the sensors 206 may also occur when a user is close to the vehicle 200, for example, when the user opens the vehicle doors or an associated key fob is nearby. Activation may occur when the user scans a barcode in a store, for example, a UPC label. The storage optimization component 408 may calculate the available space 224 within the vehicle 200. This calculation may be determined by taking the dimensions within the vehicle 200 and subtracting the area occupied by any detected items. In addition, the sensors 206 may also be used to detect dimensions of the vehicle 200. The sensors 206 may dynamically determine the dimensions by scanning the interior of the vehicle 200. The available space 224 may also be determined through any of the machine vision techniques described above. The available space 224 may also be dependent on characteristics of those items which may be determined through the images taken of them. In one example, the storage optimization component 408 may determine that the items should not be stacked, e.g. the items may have an irregular shape or they may be fragile. The available space 224 may be reduced when the items are not stackable. The images taken of the items may be used to detect that there are areas where other items may be placed through, for example, items may be placed within gaps within a dining set. The storage optimization component 408 may also consider passenger occupancy in the present or future, items to be loaded or removed in the future (not at a single stop), and external storage areas. For example, a seat may be used for a new occupant if a passenger is to be picked up during a trip. In one embodiment, the seat may be occupied by items if there is a delivery at a point before a passenger is loaded in. One or more passengers may be accounted for when determining the available space 224 within the vehicle.

In one exemplary embodiment, the storage optimization component 408 may compare the characteristics of the items to be obtained and loaded into the vehicle 200, to the available space 224 in each configuration 222, 226, 228. The comparison may initially be a high level comparison using only the size or dimensions of the items to determine the selected configuration. Based on this high level comparison, the storage optimization component 408 may select a configuration. For example, the storage optimizer 408 may determine the overall size of the base of each of the items. The base may be the portion of the item that will rest on the floor of the storage area that it is placed into. The size of the base of each of the items may be compared to the size of the floor of the available space 224. If the total size of the base of the items is a certain predetermined amount larger or less than the size of the floor of a configuration, then that configuration may be selected as the configuration to use. In another exemplary embodiment, the storage optimization component 408 may select the configuration with the highest amount of available space 224.

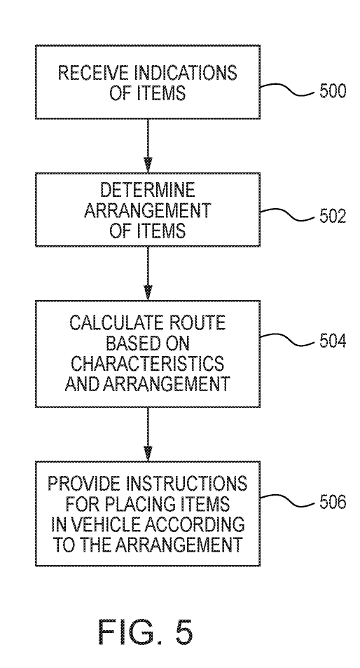

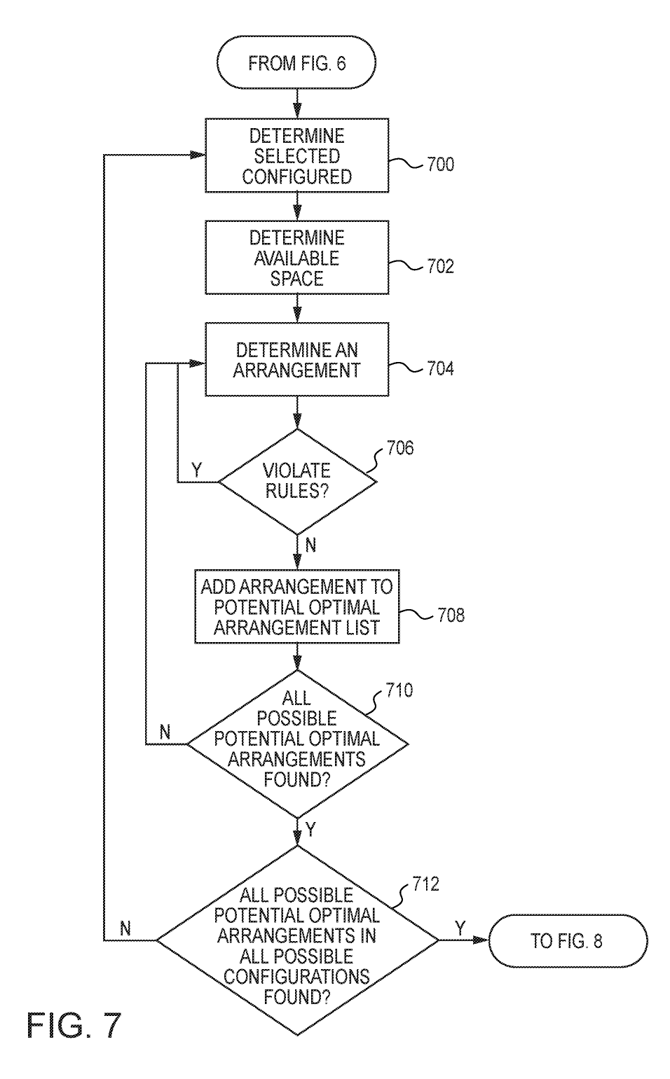

The storage optimization component 408 may also determine how the items will be arranged within the selected configuration. The storage optimization component 408 may determine the arrangement as a final arrangement at the end of a trip or may determine a plurality of arrangements, one arrangement for each location where one or more items will be obtained or delivered throughout the trip. The storage optimization component 408 may also determine both a final arrangement and intermediate arrangements. Intermediate arrangements may include the arrangement of items at intermediate locations of the entire trip. For example, the arrangement of a first item and second item in the vehicle before obtaining a third item may be considered an intermediate arrangement. Details of how the optimal arrangement and intermediate arrangements may be determined will be described below with reference to FIGS. 5 and 7.

Continuing with FIG. 4, the storage optimization component 408 may provide the optimal arrangement and characteristics of the items to the navigation component 410. The navigation component 410 may be responsible for determining an optimal route for obtaining and/or delivering the items. The navigation component 410 may be in computer communication with a sensor 206, such as a GPS, to determine the current location of the vehicle and the locations of the items to be obtained or the locations where items may be delivered. Considering the locations associated with the items and the current location of the vehicle 200, the navigation component 410 may calculate an optimal route for the vehicle to travel to obtain and/or deliver all of the items.

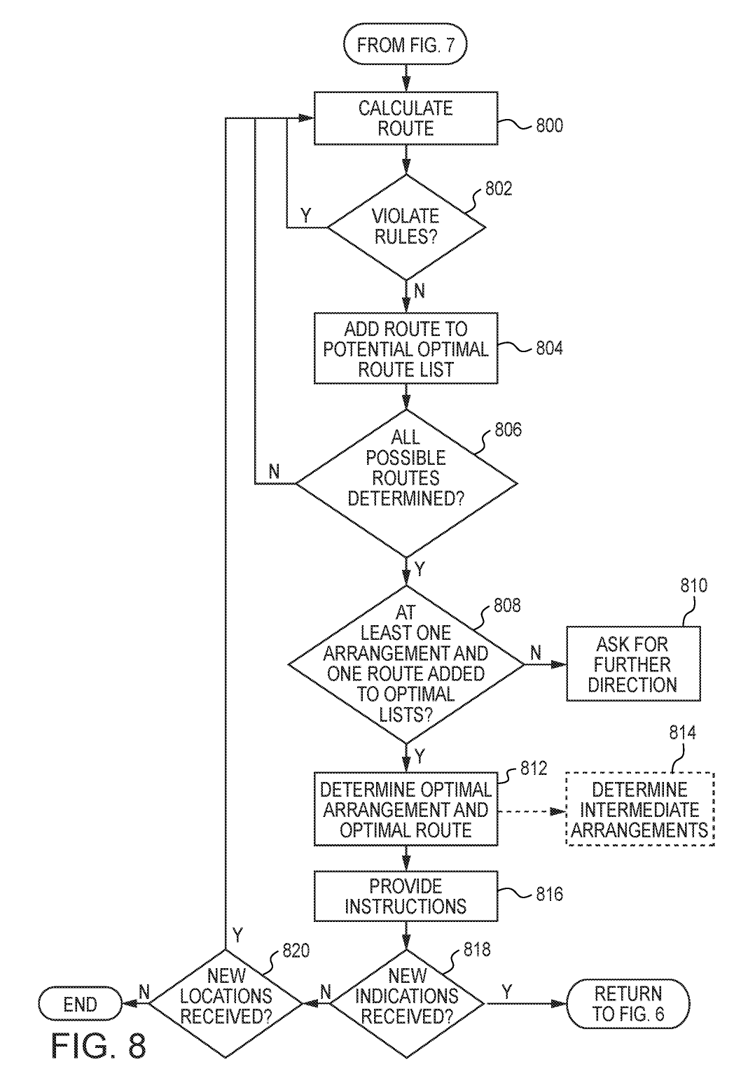

In one exemplary embodiment, the optimal route may be based on the arrangement of items. For example, the first location in the route may be the location at which the first item may be obtained, where the first item is the item furthest from a particular entry point of the vehicle, such as the tailgate of a van type vehicle. The second location in the route may be the location at which the second item may be obtained, where the second item is the item second furthest from the entry point of the vehicle. The optimal route may also consider any time elements. For example the second item may need to be picked up between 2:30 and 4:00 pm. The optimal route would take this into consideration along with other characteristics of the items. Addition details of the navigation component 410 will be described below with reference to FIGS. 5 and 8.

The storage optimization component 408 and/or the navigation component 410 may provide the optimal arrangement and optimal route to the output component 412. The output component 412 may be responsible for providing the optimal arrangement and optimal route to the user through a set of instructions. The output component 412 may be communicatively connected to the display 308, speaker 311, and/or any other device connected to the I/O interface 310. The instructions may be provided in an audio format, a visual format, or a combination. The instructions may be read to the user in an audio format through the speakers 311, displayed for the user through the GUI 320 on the display 308 or some combination thereof. The instructions may include instructions for routing to a first location, for placing a first item into the vehicle according to the optimal arrangement, for routing to a second location, for placing a second item into the vehicle according to the optimal arrangement, etc. This may be performed on the vehicle 200 or on another component within the environment 100 including the computing device 300 or server 106. Further, these instructions may include instructions regarding items already loaded on the vehicle 200, for example, instructions to rearrange existing items may be provided.

In one exemplary embodiment, one or more automated actions may be performed to facilitate carrying out the instructions, such as automatically folding seats down, adjusting positioning of seats, etc., which will be described below. In one embodiment, the height of the vehicle 200 may be adjusted on its sides. For example, if one entry point of the vehicle 200 is already full as determined by the sensors 206 within the vehicle 200, or other method, the other side may be lowered to indicate to the user that the items should be placed into the vehicle 200 through the other side. Actuators 208 within the vehicle 200 may be used to lower or raise either side of the vehicle 200.

Turning now to FIG. 5, an exemplary process for obtaining and loading items into a vehicle 200 will be described. The process begins at block 500 where the identification module 402 may receive one or more indications of one or more items to be obtained. The indications may include characteristics of the items. At block 502, the storage optimization component 408 may determine an optimal arrangement of the items within the vehicle 200. The arrangement of the items may take into account the characteristics of the items and the locations where the items are to be obtained. Next, at block 504, the navigation component 410 may calculate an optimal route based on the characteristics of the items and the optimal arrangement. Finally, at block 506, the output component 412 may provide instructions for routing to the locations according to the optimal route and placing the items in the vehicle 200 according to the optimal arrangement.

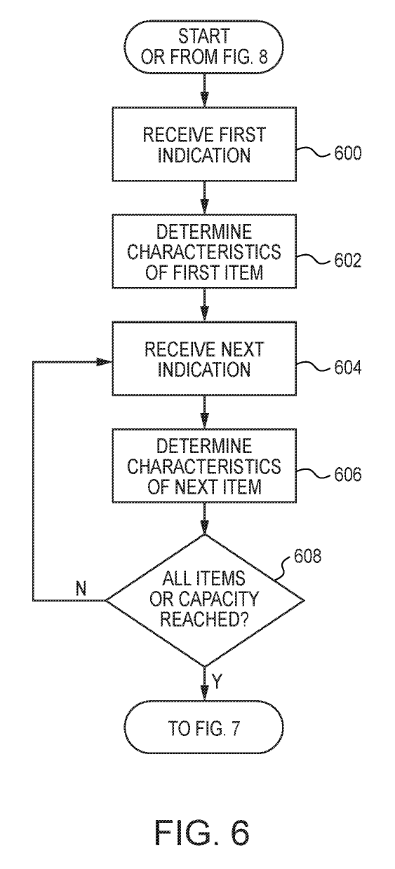

Referring now to FIGS. 6-8, another exemplary process for obtaining and loading items into a vehicle 200 will be described. The process may begin at block 600 where the identification component 402 may receive a first indication of a first item to be obtained and loaded into the vehicle 200. As discussed above, the indication may be received from a shopping component 404 and/or a scanning component 406. Next, at block 602, the identification component 402 may determine one or more characteristics about the first item. In one example, using the shopping component 404, the user may add a couch to a shopping list. The shopping component 404 may send an indication of the couch to the identification component 402. The indication may include the location of the couch (Furniture Store A, including its address), identity of the item (couch) and the dimensions of the couch (certain height, width and length). The identification component 402 may store this information in memory 304. Other methods of receiving the indication of the first item may be used.

At block 604, the identification component 402 may receive a second indication of a second item to be obtained and loaded into the vehicle 200. Next, at block 606, the identification component 402 may determine one or more characteristics of the second item. Continuing the previous example, again using the shopping component 404, the user may add a lawnmower to the shopping list. In this example, the identification component 402 or shopping component 404 may perform text analysis on the description of the lawnmower in the shopping component 402 in order to determine the location of the item (Lawn and Garden Store B), the identity of the item (lawnmower, model# ABC123) and its characteristics (box size and weight). In one exemplary embodiment, the shopping component 404 may complete a search through the Internet to determine the most appropriate location to buy the model# ABC123 lawnmower. Once the shopping component 404 has determined the most appropriate location, it may be stored in memory 304 as the location to obtain the second item.

Next at block 608, the identification component 402 may determine if it has received indications for all of the items to be obtained and loaded into the vehicle 200. If yes, the process continues on FIG. 7. If no, the process proceeds back to block 604 where the next indication may be received by the identification component 402. Continuing with the above example, the next indication may be for three bags of mulch. At block 606, the identification component 402 may then determine one or more characteristics about the next indication. For example, the indication may include the dimension and weight of the bags of mulch. The identification component 402 may determine that the three bags of mulch may be obtained at the same location as the lawnmower (Lawn and Garden Store B). This process of adding items to a shopping list and providing indications of items to be obtained and determining characteristics of the items may continue until the identification component 402 determines all items have been indicated or until a maximum capacity of the vehicle has been reached. Continuing with the example above, the user may continue to add items, such as groceries to the shopping list. The shopping component 406 may estimate how many bags will be necessary to hold the groceries and an indication of 6 bags of groceries to be obtained at Grocery Store C may be provided to the identification component 402. Finally, at block 608, the user may indicate that this is all of the items that will be obtained and/or delivered on this trip. The process continues with reference to FIG. 7.

At block 700, the storage optimization component 408 may select a configuration of the vehicle to receive the items indicated to the identification component 402. In one exemplary embodiment, the storage optimization component 408 may compare the characteristics of the items to be obtained and loaded into the vehicle 200, to the available space 224 in each configuration 222, 226, 228. For example, the storage optimization component 408 may determine the overall size of the base of each of the couch, lawnmower, mulch and groceries and compare this to the size of the floor of the available space 224 in the available configurations. In this example, the size of the base of the couch, lawnmower, three bags of mulch and 6 bags of groceries may be larger than the size of the floor of the configuration with the highest amount of available space 224, this being the configuration 228 shown in FIGS. 2D and 2E. In this example, the configuration 228 would be selected as the selected configuration.

At block 702, the storage optimization component 408 may determine the available space 224 of the selected configuration. As discussed above, the available space 224 may be determined through several methods. Next, at block 704, the storage optimization component 408 may determine an arrangement of the items in the available space 224. In one exemplary embodiment, an initial arrangement of the items may be determined. This initial arrangement may include arranging the items in the available space 224 in the order they were identified. Other initial arrangements may be determined randomly. Once the initial arrangement is determined, the initial arrangement may be compared with a plurality of arrangement rules at block 706.

The arrangement rules may include a list of criteria for determining the placement of items with regard to other items or the placement of items having certain characteristics with regard to other items or the location that item should be placed. Example arrangement rules may include but not be limited to: heavier items on the bottom; heavier items placed near the doors, larger items on the bottom (to establish a solid base or foundation), tall items secured from toppling over, lighter items on top, heavy items protected from sliding forward or backward during hard braking or acceleration, keep cold or perishable items out of the sun. Other item characteristics may be considered in the arrangement rules, such as the dimensions, shape, weight, fragility, material, perishability and stackability of the items. For determining the placement of items on the exterior of the vehicle 200, either on the roof or in an open truck bed in a truck type vehicle, additional criteria may be considered. For example, the wind may be one consideration when placing items onto the exterior. The higher the item is placed, the more the wind may affect the item. Height data from the bottom of the open cargo bed to the top of the vehicle 200 may be used to determine how to place the items in the vehicle 200. Using distance and time on the road, the arrangements and routes may be adjusted. For example, items may be packed differently for a trip that takes a couple of minutes versus a trip that takes hours. Items that are heavier in weight such as concrete may be placed towards the back of an open cargo bed such that they may be loaded and/or unloaded from the truck more efficiently. Lighter items such as flowers should typically not be placed behind or in front of heavier items, such as concrete, due to the acceleration or braking of the vehicle which may cause the concrete to slide back or forward into the flowers, crushing them. The arrangement rules may also include user preferences, such as, arrangement preferences (certain types of items always on top, placement on the exterior roof not allowed, etc.), whether rearranging of items is permitted at each stop, personal characteristics, such as, age, health, size, medical conditions/restrictions. Rules may be prioritized by user preference or some default order. In one exemplary embodiment, the arrangement rules and user preferences may be customizable by the user.

If, at block 706, the storage optimization component 408 determines that one or more of the arrangement rules are violated by the initial arrangement, the storage optimization component 408 may proceed back to block 704. At block 704, the storage optimization component 408 may determine a second arrangement. The second arrangement may be determined based on the initial arrangement, the identity of the items, characteristics of the items, and/or the available space in the vehicle. The second arrangement may once again be compared to the arrangement rules at block 706. If the storage optimization component 408 determines one or more of the arrangement rules are violated by the second arrangement, then the process again returns to block 704. This process may be repeated until an arrangement is found that does not violate any arrangement rules, violates a minimum number of rules or meets some threshold number of rules. Once an arrangement is found, the process continues to block 708.

At block 708, the storage optimization component 408 may add the arrangement to a potential optimal arrangement list. The potential optimal arrangement list may include any arrangement that does not violate any arrangement rules, violates a minimum number of rules or meets some threshold number of rules depending on the criteria established by the storage optimization component 408 or through user preferences. Next, at block 710, the storage optimization component 408 may determine if all of the possible potential optimal arrangements for the selected configuration have been found. In one exemplary embodiment, the storage optimization component 408 may determine this by tracking the arrangements that have been identified and continue to determine arrangements until a duplicate arrangement is found. In another exemplary embodiment, the placement of each item in the available space 224 may be tracked and the process may continue until each item has been placed in every possible placement in the available space 224, taking the other items into consideration. In the example used above, the couch may only have two possible placements within the available space 224 because of its dimensions. In addition, the lawnmower box may be limited in its placement because the couch is included in the arrangement. If it is determined that not all of the possible potential optimal arrangements have been found, then the process returns to block 704. If all of the possible potential optimal arrangements have been found then the process proceeds to block 712.

At block 712, the storage optimization component 408 determines whether or not all possible potential optimal arrangements have been found for all possible configurations. If yes, the process continues on FIG. 8. If no, then the process returns to block 700 and a new configuration is selected and the process repeats until all possible potential optimal arrangements for all possible configurations have been added to the potential optimal arrangement list.

Referring now to FIG. 8, the process continues at block 800 where the navigation component 410 may determine an initial route based on the arrangement and the characteristics of the items. At block 802, the navigation component 410 may compare the initial route to one or more route rules. The route rules may be a list of criteria used to determine how and in what order to drive to each location to obtain and/or deliver the items. The route rules may include: go in the order that items are arranged (furthest in is the first store visited, etc.), maximize right turns, minimize time, miles or fuel (gas, hydrogen, and/or electric charge), minimize covering same roads in opposite direction, amount of time items will spend in the car, traffic, etc. The route rules may also include user preferences such as use surface roads v. freeways, store location preferences (e.g. Grocery Store C on Main Street vs. Grocery Store C on Fifth Avenue), etc. If the initial route violates one or more route rules then the process may return to block 700 and a second route may be determined. This process may be repeated until a route is found that does not violate any route rules, violates a minimum number of route rules or meets some threshold number of route rules. Once a route is found, the process continues at block 804.

At block 804, the route is added to a potential optimal route list. The potential optimal route list may include any route that does not violate any route rules, violates a minimum number of route rules or meets some threshold number of route rules depending on the criteria established by the navigation component 410 or through user preferences. Next, at block 806, the navigation component 410 may determine if all of the possible potential optimal routes have been determined. If, at block 806, it is determined that not all possible potential optimal routes have been found, then the process may return to block 800. Alternatively, blocks 800-806 may iterate until a predetermined number of potential optimal routes are found. Next, at block 808, the navigation component 410 (and/or the storage optimization component 408) may determine whether or not at least one potential optimal arrangement and at least one potential optimal route have been added to the potential optimal arrangement list and potential optimal route list. If no, then further instructions may be obtained from the user at block 810. For example, the user may be prompted to pick between two suboptimal routes or arrangements. A suboptimal route and/or arrangement may include a route that requires backtracking, rearrangement in the middle of the route or not obtaining one item, etc.

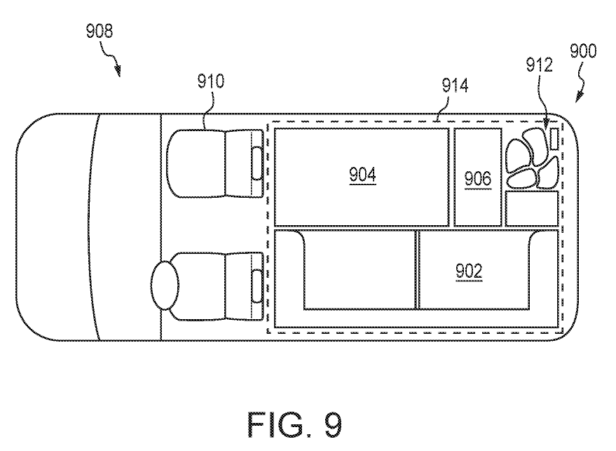

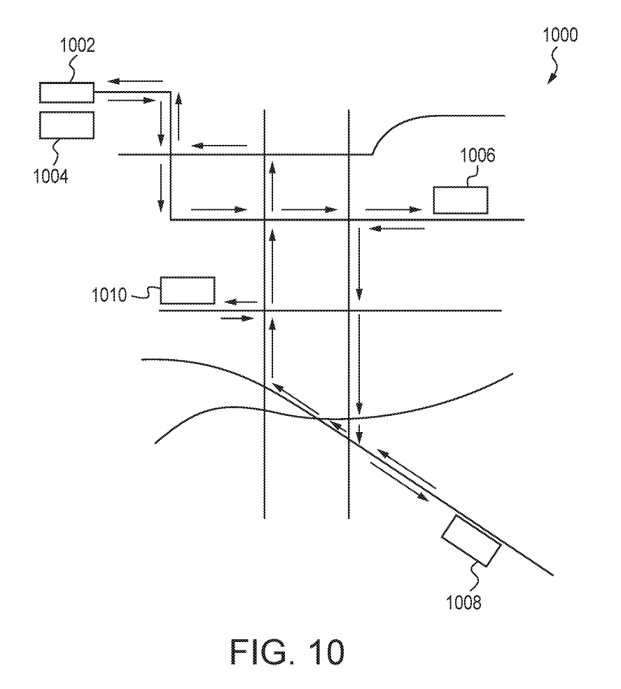

If, at block 808, there are at least one potential optimal arrangement and at least one potential optimal route on the potential optimal arrangement list and potential optimal route list, then the process continues to block 812. At block 812, the storage optimization component 408 and/or the navigation component 410 determine the optimal arrangement 900 and the optimal route 1000. Examples of the optimal arrangement 900 and the optimal route are shown in FIGS. 9 and 10, respectively. The optimal arrangement 900 may be determined based on a comparison of the potential optimal arrangements on the potential optimal arrangement list. The potential optimal arrangements may again be compared to the arrangement rules and item characteristics to determine which of the potential optimal arrangements is the most optimal. The optimal route 1000 may be determined based on a comparison of the potential optimal routes on the potential optimal route list. The potential optimal routes may be compared to the route rules and item characteristics to determine which of the potential optimal routes is the most optimal. In one exemplary embodiment, the potential optimal arrangements and potential optimal routes may be compared to each other to determine which arrangement works best with which route. For example, a first arrangement may work well with a first route but not a second route. If the first arrangement were used with the second route a rearrangement may be required which may violate more arrangement rules than if the first arrangement were used with the first route. In another example, a first route may be more efficient than a second route which is rated as a higher priority that other route rules. A second arrangement may be better that the first arrangement for the first route. Other scenarios and examples of determining an optimal arrangement and optimal route may be possible.

Optionally, at block 814, the storage optimization component 408 may determine one or more intermediate arrangements. Intermediate arrangements may include the arrangement of items at intermediate locations of the entire trip. In one exemplary embodiment, an intermediate arrangement may be included for every location where an item is obtained. The intermediate arrangement may include an optimal arrangement for the items in the vehicle at time, after that location until the next item is obtained at the next location. For example, an intermediate arrangement may be the arrangement of a first item and a second item in the vehicle before obtaining a third item. The intermediate arrangements could include folding only one seat down for the first location but at the second location both seats are folded down and stowed. This may minimize sliding of the item stowed during the drive to second location. In another exemplary embodiment, the intermediate arrangements may be considered individual blocks in following the optimal arrangement, in other words no rearrangements or changes in configuration may be necessary. Other intermediate arrangements may be considered.

Next, at block 816, the output component 412 may provide instructions to the user of how to follow the optimal route 1000 and optimal arrangement 900. Next, at blocks 818 and 820, the situation may be monitored. In one exemplary embodiment, the identification component 402 and/or the storage optimization component 408 may determine whether or not any indications of new items are received, at block 818. If new indications are received, such as, for example, adding paint to the shopping list, the process may return to FIG. 6, block 600. The identification component 402 and/or storage optimization component 408 may also determine whether or not any new locations are received at block 820. If any new locations are received, then the process returns to block 800. If not, the process ends. In one exemplary embodiment, new locations may be received when new indications of items are received. In another exemplary embodiment, a new location may be received when an item is lost from the vehicle, as will be described in more detail below.

As described above, FIG. 9 illustrates an exemplary embodiment of an instruction for showing the optimal arrangement 900 of the items. Continuing the previous example, the optimal arrangement 900 may be determined based on the size and weight of the couch 902, lawnmower box 904 and bags of mulch 906. The couch 902, because of its size, may need to be placed into the vehicle 908 longitudinally (the direction the vehicle drives). The lawnmower box 904 may be placed next to the couch and further inside the vehicle 908 than the bags of mulch 906 since it weighs more and would be protected from sliding forward during sudden braking by the front passenger seat 910. The bags of groceries 912 may be placed in the most rearward position to protect them from being crushed by other items during sudden braking. This arrangement 900 uses the available space 914 within the vehicle 908 while violating fewer rules than other possible arrangements.

As described above, FIG. 10 illustrates an exemplary embodiment of an instruction for showing the optimal route 1000 for the user to follow to obtain the items. Continuing the example, the vehicle 1002 may start at the user's home location 1004. The optimal route 1000 may instruct the user to drive from their home location 1004 along the roads as indicated to Furniture Store A 1006. The instructions may then highlight couch 902 on the optimal arrangement 900 to show where it should be placed in the vehicle 1002. The highlighting may take the form of changing colors, changing boldness or flashing the item on the display 308 or GUI 320. The instructions may then show the user how to route to Home and Garden Store B 1008 and highlight the lawnmower box 904 and mulch 906 on the arrangement 900 to indicate where they should be placed once they are obtained. Next, the instructions may show the user how to route to Grocery Store C 1010 to obtain the six bags of groceries 912, highlighting on the arrangement 900 where the bags 912 should be placed. Finally, the instructions may route the user back to their home location 1004. Other ways of providing the instructions may be contemplated. For example, the instructions may be textual or video. The instructions may be provided as a list. The arrangement instructions and routing instructions could be combined into one long list of instructions with pictures or videos included as each block in the instructions is completed. In another exemplary embodiment, the instructions may be provided as part of navigation-style routing directions.

Other methods than the methods shown in FIGS. 5-8 may be contemplated. In one exemplary embodiment, the optimal arrangement and optimal route may be determined through a scoring procedure. For example, scores may be assigned to the arrangement rules and the route rules. The scores may include the weighting of the rules. More important rules may be assigned a higher score. Potential optimal arrangements and routes may be compared to the arrangement rules and route rules. Any violated rules may have their score added against the potential optimal arrangement or route. The potential optimal arrangement and route with the lowest score could be considered the optimal arrangement and route. Alternatively, the potential optimal arrangements and routes could be paired and scored together. The lowest scoring pair may be considered the optimal arrangement and route. An opposite scoring procedure is also possible where points are awarded when rules are not violated or when rules are followed. For example, points may be awarded when a heavier item is placed below a lighter item. Other scoring methods may also be included.

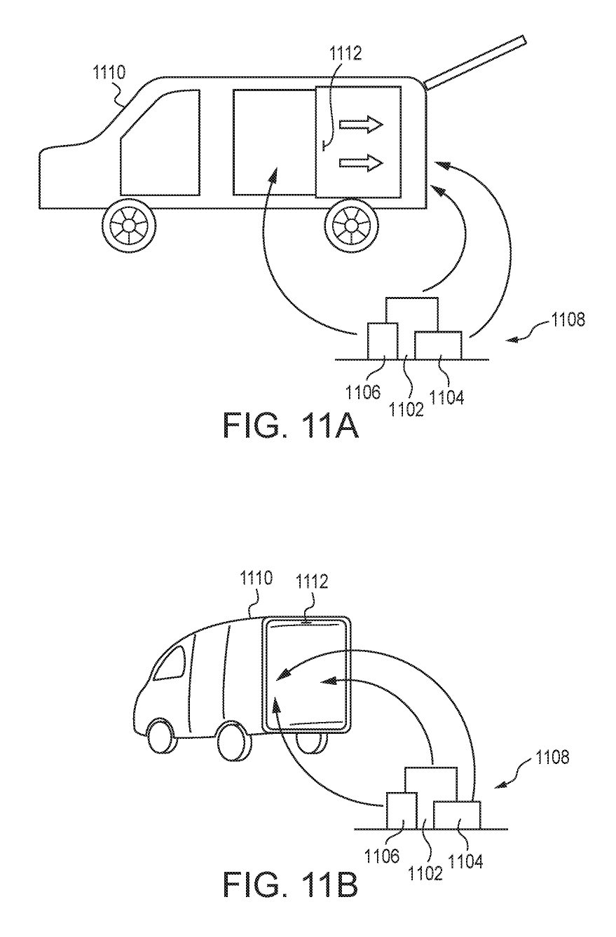

FIG. 11A provides another exemplary embodiment illustrating another arrangement for placing items 1102, 1104 and 1106 (collectively items 1108) into the vehicle 1110. The arrangement, which is exemplary, shows that a bulkier item 1102 should be placed first, and smaller items 1104 and 1106 are placed in second and third. Arrangements may also include which doors are to be used for placement of the items 1108. As will be shown below, actuators 1112 on the vehicle 1110 may be automatically activated depending on the arrangement. FIG. 11B depicts another arrangement where the items 1108 are placed in the back of the vehicle 1110. Item 1106 may be placed in first and item 1102 and item 1104 placed in second and third. This arrangement may be based on, for example, that item 1106 is a last item to be taken out.

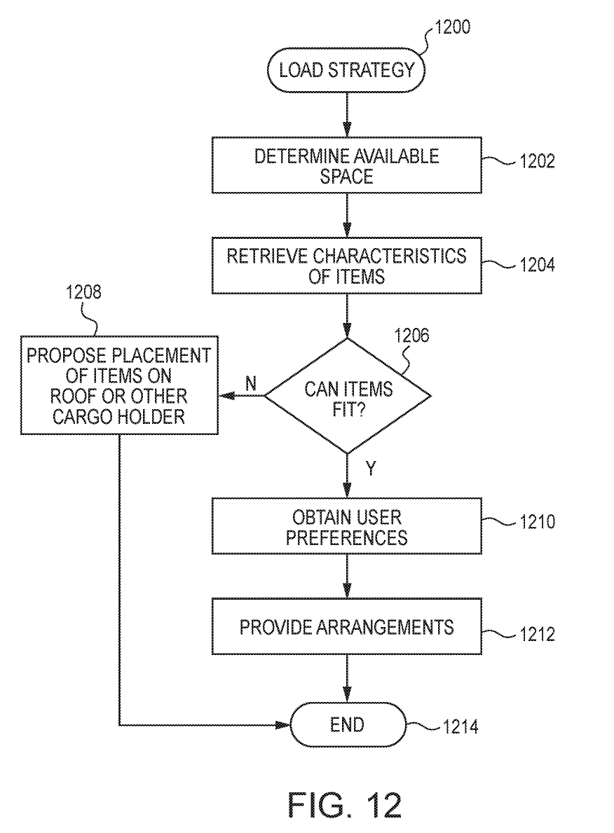

Referring to FIG. 12, a flow chart showing other exemplary processes for providing an arrangement in accordance with one aspect of the present disclosure is provided. The processes may begin at block 1200. The arrangement may be determined by the vehicle 1110, computing device 300, server 106 or other component. At block 1202, available space within the vehicle 1110 may be determined. At block 1204, characteristics for the items 1108 may be retrieved.

At decision block 1206, a determination is made on whether the items 1108 may be fit into the vehicle 1110. This determination may be made on the vehicle 1110, computing device 300, server 106 or a combination of the components within the environment 100. Available space may be taken along with those items to be placed into the vehicle to determine whether those items 1108 may be placed in.

In one embodiment, each item 1108 is taken and virtually placed into the vehicle 1110. Then another item 1108 may be loaded and so on. If at the end, the items 1108 are not able to fit into the vehicle 1110, this particular arrangement would not work. However, if it does fit, then this would be one potential optimal arrangement. This method involves trial and error methods through virtually placing the items. Optimizations of this method may be used. For example, arrangements that would be technically feasible but impractical due to the characteristics of the items would not be considered. Also, and as will be shown below, user preferences may be determined to remove some arrangements. The arrangements would take into account of different entry points of the vehicle 1110.

Another method for determining possible arrangements is taking previously used arrangements and fitting the new items 1108 into the vehicle 1110. For example, if the user places certain items 1108 first and other items afterwards, then this may be used to produce new arrangements. This method, like before, may take into account the characteristics of the items 1108 that were previously loaded in first and afterwards. Mimicking these strategies may be used and followed for the arrangements.

As shown above, a number of possible arrangements for loading the items 1108 into the vehicle 1110 were shown. When the items 1108 cannot fit within the vehicle 1110, a proposal may be made to place the items 1108 on the roof or other cargo holder on the vehicle at block 1208. In one embodiment, suggestions may be made that some items 1108 should not be purchased or carried within the vehicle 1110. The processes may end at block 1214.

If the items 1108 may be placed into the vehicle 1110, preferences may be obtained at block 1210. At block 1212, based on the available space, characteristics of the items 1108, and the user preferences, at least one arrangement is provided to the user. As described above, multiple arrangements may have been determined based on the available space, which may also have taken into account the characteristics of the items 1108. These arrangements, in one embodiment, may be narrowed down to provide an arrangement that is based on the user preferences. For example, arrangements that would require lifting heavy items 1102 into the interior compartment of the vehicle 1110 may be removed if the user preferences indicate that the user is older.

In another example, the user may prefer, and as indicated by their user preferences, to load items 1108 near entry points in the vehicle 1110 evenly. This may be determined through historical usage and tracking of the user. Arrangements that were determined earlier may be eliminated that do not coincide with the user's preferences of placing items 1108 at entry points. Alternatively, the user may prefer to place items 1108 almost always in the back of their vehicle 1110. For example, minivan drivers may prefer to load items 1108 into the back of the vehicle 1110 as generally their vehicles 1110 have a number of occupants filling up space at other entry points.

Items for placement into the vehicle 1110 and exemplary arrangements were described above. Factors such as characteristics of the items as well as available space in the vehicle 1110 were determined to provide such arrangements. Furthermore, routes that include a number of stops along a user's trip should be taken into account of when providing such arrangements.

In one exemplary embodiment, the user may go into a store and scan the bar code of an item for purchase. Available space information in the vehicle may be calculated. Based on the available space and the characteristics of the item, a determination may be provided as to whether the item should be purchased. In one embodiment, others may be allowed to scan items for purchase. A store may receive the item from its main distribution center and when the item arrives, a notification may be provided to the user that their item is ready for pickup. The storage optimization component 408 may then use this information for determining whether there is enough space in the vehicle 1110 to obtain the item.

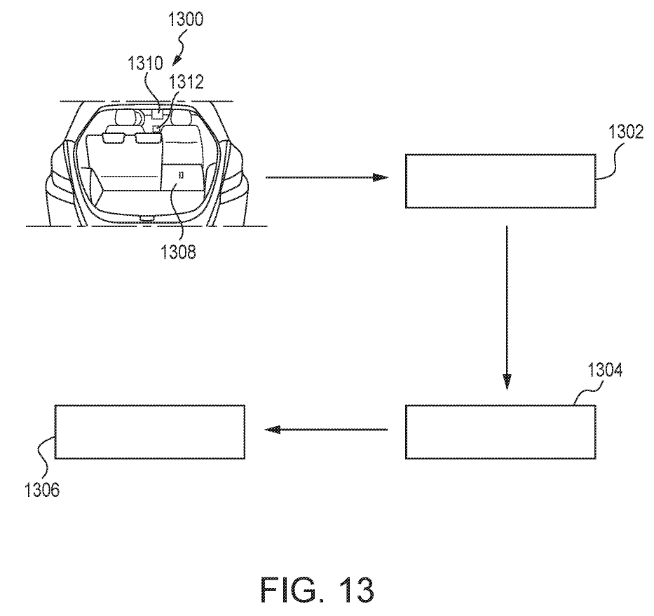

Another exemplary scenario for route planning in accordance with one aspect of the present disclosure is provided in FIG. 13. The scenario provides an exemplary situation; it should not be construed as limiting. Arrangements may take into account a user's route which often includes multiple stops. Items may be obtained or delivered at each stop.

Route planning may provide a detailed summary of which stores to go to based on distance and arrangement of the items into the vehicle 1300 or removing them therefrom. Minimal rearrangement of items would be a determinative factor. For example, purchasing bulky items 1102 first and then filling up other items 1104 and 1106 would be one arrangement, as shown in FIG. 11A. If a bulkier item is to be returned, that item may be loaded last into the vehicle 1300 before the user begins their trip. In one embodiment, route planning may take into account of whether additional space would be available by fitting items on the roof. Tie downs may be used and/or recommended. Material considerations may be determined to reduce or remove scratches from the roof of the vehicle 1300.

Temperature arrangements may be determined for various items. For example, in the following scenario, food items may be purchased last to preserve them. The route may also dynamically adjust for items that require pickup or delivery. In one embodiment, a UPC label, or the like, may be scanned notifying the driver that a package is to be picked up. An arrangement may be adjusted along with the route and presented to the driver. This would account for the characteristics of the items and the available space in the vehicle 1300.

Continuing with the scenario, a typical route is planned and shown which takes into account the available space. Beginning, the driver of the vehicle 1300 may have a preset route detailing a number of stops. Items may be entered in and a route may be planned showing a number of delivery and pickup locations. The route may be determined using a number of different criteria or factors. For example, personal preferences and locations and characteristics of the items to be obtained or delivered are used.

In one embodiment, determining locations of the items may include identifying stores with the items based on price. For example, the route may be based on a price threshold and if the item is less than that threshold, the location may be determined and the route may be adjusted. Stores having the items above that threshold would be eliminated from consideration when coming up with the route.

At a first stop 1302, the driver has provided that they wish to pick up clothes at a department store. The arrangement may account for whether the clothes are packaged. During the drive, a UPC label has been scanned at a second store. The items may be a food items showing that the newest batch of strawberries has come in. This information is provided and the route is regenerated to account for a new arrangement.

At the second stop 1304, the route directs the user to pick up the strawberries. The remaining items for pick up or delivery are taken into account of on whether this item should be picked up now or later, partially based on whether the items may spoil. If the item is likely to spoil, then the item may be routed to as a last stop. Concluding the scenario, the route may direct the user to pick up their dry cleaning at the third stop 1306. Throughout, arrangements were used in combination with a route. Both may be dynamically updated during the trip.

The route was generated based on the locations and characteristics of the items and the available space in the vehicle 1300. The clothes packed in boxes would be placed in first because they are easily stackable and would not spoil. The groceries were then loaded in as they would spoil, however, they were picked up before the last stop 1306, where the laundry was picked up, because the laundry would be crushed if occupants were coming in and out of the vehicle 1300 or other items were taken in and out of the vehicle 1300.

A number of different scenarios may be contemplated for which a route may be generated along with arrangements and are not limited to the example shown above. Each of the stops 1302, 1304 and 1306 were shown for illustrative purposes. In another example, the first stop 1302 may be where the driver picks up a number of items such as their parents' house which would occupy a large amount of space within the vehicle 1300. At the second stop 1304, the driver would pick up their child and at the third stop 1306; the driver would pick up additional items. Based on this scenario, an arrangement would be provided that would save space for their child at the second stop 1304. The arrangement would also be based on loading the items at the third stop 1306, potentially through the use of another entry point such that items from the first stop 1302 would not have to be shifted or repositioned.

The stops 1302, 1304 and 1306 may be much further than those disclosed above. For example, the driver may be going on a long distance road trip where items may be used at different stops along the way. At the first stop 1302, the driver's house, the items would be loaded on dependent on the second stop 1304 and the third stop 1306. The driver may plan to camp out at the second stop 1304 so items required for camping would be placed in last while items used at the third stop 1306 would be placed at an interior portion of the vehicle 1300.

In another exemplary embodiment, the route could be determined first and the arrangement determined second. The route could be optimized and the arrangement determined based on the route. For example, the optimal arrangement could be determined based on the order that the items will be obtained and loaded into the vehicle while following as many arrangement rules as possible.

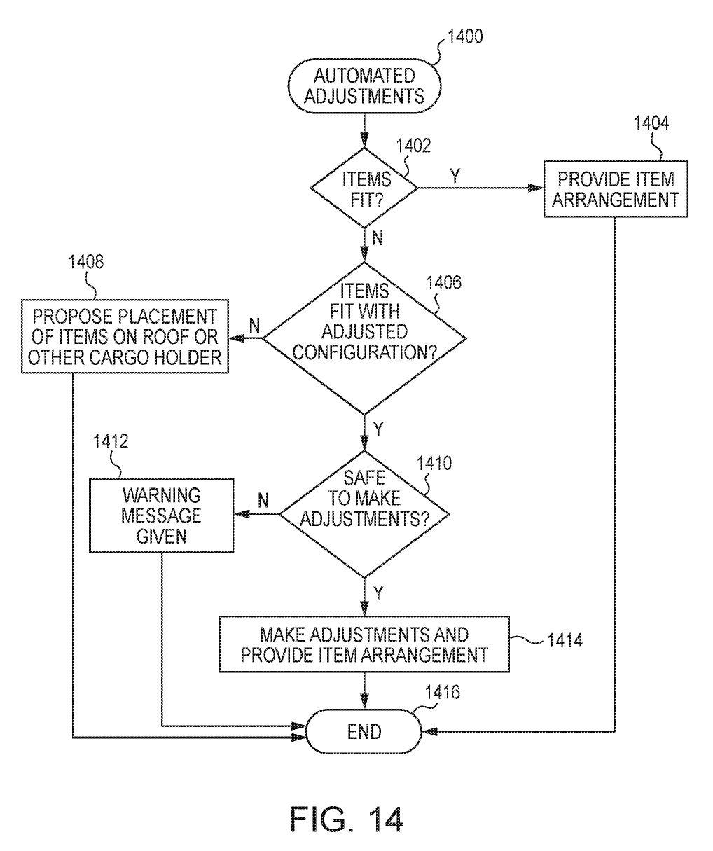

Turning to FIG. 14, an exemplary flow chart showing processes for determining whether adjustments should be made in accordance with one aspect of the present disclosure is provided. The processes may begin at block 1400. At decision block 1402, a determination is made whether the items may fit into the vehicle 1300 without adjustments. These items may be manually or automatically entered in, as described above. When the items may be placed into the vehicle 1300, an arrangement is provided to the user at block 1404. The processes may end at block 1416. When, however, the items may not fit without adjustments, at decision block 1406, a determination is made whether the items may fit into the vehicle 1300 with adjustments. If not, at block 1408, a proposal is made to the user to place items on the roof or other cargo holders. The proposal may request that the user bring tie downs. The processes may end at block 1416.

When, however, the items may be placed into the vehicle 1300 with adjustments, at decision block 1310, a determination is made whether activating the actuator 1308 is safe. For example, when other items are located on the seat, then the actuator 1308 would not be adjusted. Sensor 1310 within the seat may be used. In another embodiment, sensors around the vehicle 1300 may be used to determine whether it would be safe to raise or lower the vehicle 1300.

When activating them would be unsafe, an error message or warning may be provided at block 1412. Specific warnings may be provided, for example, there is another items on the seat. The processes may end at block 1416. When it is safe, however, then adjustments are made and the user is provided with an arrangement at block 1414. These adjustments may be made automatically or through a confirmation button located on the computing device 1312, for example. The processes may end at block 1416.

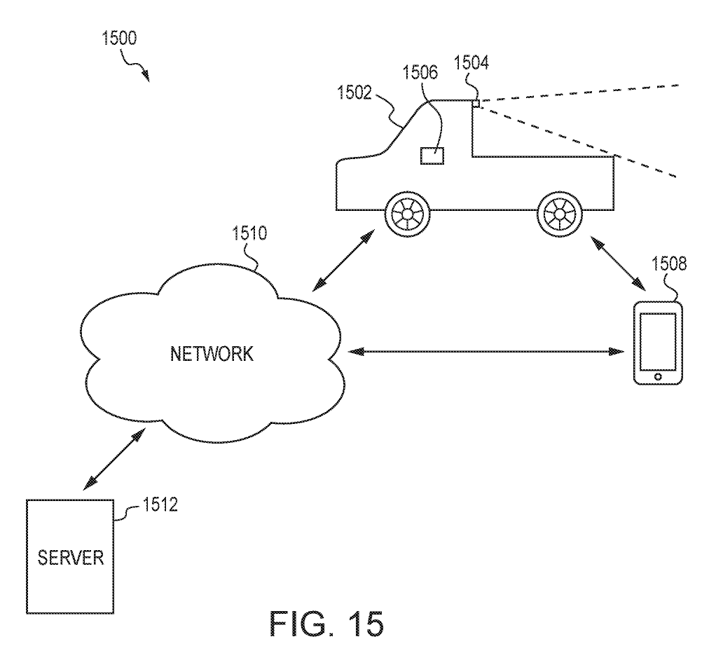

Once items are loaded into the vehicle according to the arrangement, they may be monitored as discussed above. Some configurations or arrangements may require that the items be exposed to the vehicle exterior. If that is the case, such as in an open cargo bed, items may be lost by flying out of the cargo bed. FIG. 15 is an illustrative system 1500 for detecting items lost from a vehicle 1502 in accordance with one aspect of the present disclosure. Sensors 1504 may be used to determine whether an item is lost. In one embodiment, the sensor 1504 may be a camera. In one example, a backup sensor may also be used for determining whether the item has fallen out. When an item is not secured or falls out of the vehicle 1502, the user may be notified.

In one embodiment, the location of the lost items may be stored. A signal may be sent from the vehicle sensor 1504 and based on that signal, the location where the items was lost may be tagged or tracked, i.e., coordinates of where the items was lost from the vehicle 1502. GPS information from the computing device 1506 or the portable electronic device 1508 may be used. A notification on the computing device 1506 or a telematics unit on the vehicle 1502 may be made to immediately notify the user of the lost item. Appropriate authorities may be notified as well. Each component of the system 1500 may communicate directly or indirectly through or not through the network 1510.

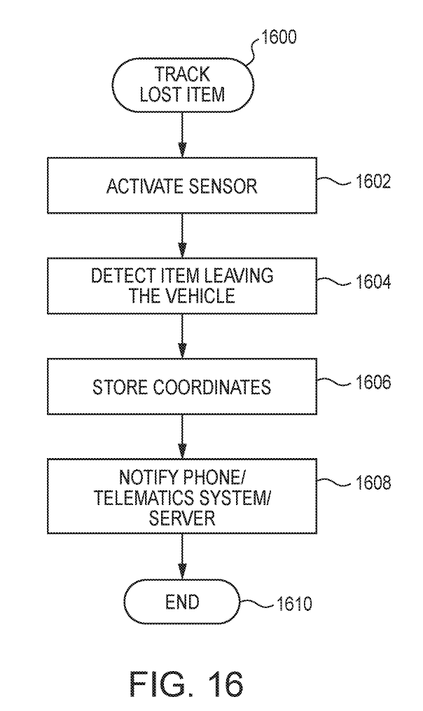

FIG. 16 is an exemplary flow chart showing processes to configure items in a truck bed in accordance with one aspect of the present disclosure. The processes may begin at block 1600. At block 1602, the sensor 1504 on the vehicle 1502 may be activated. At block 1604, an item may be detected as falling out or leaving the open cargo bed. At block 1506, coordinates may be tracked at where and when the items went missing. This may be performed through the vehicle GPS or alternatively through a computing device 1506 that may be connected or disconnected to the vehicle 1502. In one embodiment, the sensor 1504 may track the direction in which the item went for providing additional location information. For example, if the item went in a right or left direction and how fast the items was traveling when it was lost. Other types of information may be calculated including the speed of the vehicle 1502 at the time of losing the item.

At block 1608, a notification may be provided that an item has been lost. The notification may happen immediately when detected. Alternatively, the notification may be provided at a time where the driver is not distracted. Different types of notifications may be provided, for example, larger items that have been lost may be given a stronger warning. This may be provided to the computing device 1506 or the server 1512 that the item has been lost. This may be communicated via the vehicle 1502 as well. Proper authorities may be notified, such as the highway patrol or cleanup crews. The processes may end at block 1610.

The data structures and code, in which the present disclosure may be implemented, may typically be stored on a non-transitory computer-readable storage medium. The storage may be any device or medium that may store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure may be embodied as code and/or data, which may be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described may be included in hardware components. For example, the hardware components may include, but are not limited to, application-specific integrated circuit (ASIC) chips, field-programmable gate arrays (FPGAs), and other programmable-logic devices now known or later developed. When the hardware components are activated, the hardware components perform the methods and processes included within the hardware components.

The technology described herein may be implemented as logical operations and/or components. The logical operations may be implemented as a sequence of processor-implemented executed blocks and as interconnected machine or circuit components. Likewise, the descriptions of various component components may be provided in terms of operations executed or effected by the components. The resulting implementation is a matter of choice, dependent on the performance requirements of the underlying system implementing the described technology. Accordingly, the logical operations making up the embodiment of the technology described herein are referred to variously as operations, blocks, objects, or components. It should be understood that logical operations may be performed in any order, unless explicitly claimed otherwise or a specific order is inherently necessitated by the claim language.

Various embodiments of the present disclosure may be programmed using an object-oriented programming language, such as SmallTalk, Java, C++, Ada or C#. Other object-oriented programming languages may also be used. Alternatively, functional, scripting, and/or logical programming languages may be used. Various aspects of this disclosure may be implemented in a non-programmed environment, for example, documents created in HTML, XML, or other format that, when viewed in a window of a browser program, render aspects of a GUI or perform other functions. Various aspects of the disclosure may be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system for arranging items in a vehicle having an available space comprising:
an identification component receiving:
(a) a first indication of a first item to be obtained and loaded into the available space at a first location, the first indication including at least one characteristic of the first item; and
(b) a second indication of a second item to be obtained and loaded into the available space at a second location, the second indication including at least one characteristic of the second item;
a storage optimization component determining an arrangement of the first and second items within the available space based on the at least one characteristic and the first location of the first item and the at least one characteristic and the second location of the second item; and
an output component providing instructions for placing the first item and the second item in the available space according to the arrangement.

2. The system of claim 1, wherein the storage optimization component comprises:
determining a first available space in a first configuration of the vehicle; and
determining a second available space in a second configuration of the vehicle, wherein the first configuration includes stowing a seat in a seating area and the second configuration includes removing at least one seat in another seating area.

3. The system of claim 2, wherein the storage optimization component comprises:
selecting the first configuration as a selected configuration based on the at least one characteristic of the first item, the at least one characteristic of the second item, the first available space and the second available space.

4. The system of claim 3, wherein the storage optimization component comprises:
determining the arrangement of the first and second items in the selected configuration based on the at least one characteristic of the first item, the at least one characteristic of the second item, the first available space and a plurality of arrangement rules.

5. The system of claim 4, comprising a navigation component, the navigation component calculating a proposed route from the starting location to the first location and the second location based on the arrangement, the at least one characteristic of the first item and the at least one characteristic of the second item and a plurality of route rules; wherein the storage optimization component and navigation component determine an optimal arrangement and optimal route based on the at least one characteristic of the first item, the at least one characteristic of the second item, the selected configuration, the first available space, the plurality of arrangement rules and the plurality of route rules.

6. The system of claim 5, wherein the output component comprises:
providing instructions for routing to the first location, placing the first item in the first available space according to the arrangement and the selected configuration, routing to the second location, placing the second item in the first available space according the arrangement and routing back to the starting location.

7. A method for arranging items in a vehicle, comprising:
determining a space in the vehicle located at a starting location;
receiving, at an identification component, a first indication of a first item to be loaded or unloaded into the space at a first location, the first indication including at least one characteristic of the first item;
receiving, at the identification component, a second indication of a second item to be loaded or unloaded into the space at a second location, the second indication including at least one characteristic of the second item;
determining an arrangement of the first and second items within the space based on the at least one characteristic and the first location of the first item, the at least one characteristic and the second location of the second item and the space;
providing, on a display, instructions for placing or removing the first item and the second item in the space according to the arrangement.

8. The method of claim 7, wherein the first indication is received from a shopping component and wherein the at least one characteristic of the first item is determined using text analysis on a description of the first item in the shopping component, wherein the at least one characteristic of the first item is the weight of the first item.

9. The method of claim 7, wherein the second indication is received from a scanning component and wherein the at least one characteristic of the second item is determined using one or more machine vision techniques on an image of said second item received in the scanning component, wherein the at least one characteristic of the second item is the dimensions of the second item.

10. The method of claim 7, wherein determining the space in the vehicle comprises:
determining a first space in a first configuration of the vehicle and determining a second space in a second configuration of the vehicle.

11. The method of claim 10, comprising:
selecting the first configuration as a selected configuration based on the at least one characteristic of the first item, the at least one characteristic of the second item, the first space and the second space.

12. The method of claim 11, comprising:
determining the arrangement of the first and second items in the selected configuration based on the at least one characteristic of the first item, the at least one characteristic of the second item, the first space and a plurality of arrangement rules.

13. The method of claim 12, wherein the plurality of arrangement rules include one or more rules selected from the group consisting of:
heavier items arranged on the bottom, larger items arranged on the bottom, tall items secured from toppling, lighter items on top, heavy items protected from sliding forward during hard braking, and perishable items are protected from sunlight.

14. The method of claim 12, wherein the plurality of arrangement rules include customizable user preferences.

15. The method of claim 12, comprising:
calculating a proposed route from the starting location to the first location and the second location based on the arrangement, the at least one characteristic of the first item and the at least one characteristic of the second item and a plurality of route rules; and
repeating determining the arrangement and calculating a proposed route until an optimal arrangement and optimal route are identified.

16. The method of claim 15, comprising:
determining an intermediate arrangement for the first item in a third space in a third configuration, wherein the third space is smaller than the first space.

17. The method of claim 16, wherein providing instructions comprises:
providing, on the display, instructions for routing to the first location, placing the first item in the third space according to the intermediate arrangement and third configuration, routing to the second location, and placing the first and second items in the first space according to the arrangement and selected configuration.

18. The method of claim 11, wherein providing instructions comprises:
providing, on the display, instructions for routing to the first location, placing the first item in the first space according to the arrangement and the selected configuration, routing to the second location, placing the second item in the first space according the arrangement and routing to the starting location.

19. A computing device for arranging items, comprising:
a sensor analyzing and monitoring an available space in a vehicle; and
a storage optimizer:
receiving:
(a) a first indication of a first item to be obtained and loaded into the available space at a first location, the first indication including at least one characteristic of the first item; and
(b) a second indication of a second item to be obtained and loaded into the available space at a second location, the second indication including at least one characteristic of the second item;
calculating an optimal route from a starting location to the first location and the second location based on the at least one characteristic of the first item and the at least one characteristic of the second item, wherein the at least one characteristic of the first item is a time at which the first item has to be obtained and the at least one characteristic of the second item is a weight of the second item;
determining an arrangement of the first item and second item within the available space, the arrangement being determined based on the optimal route, the at least one characteristic of the first item and the at least one characteristic of the second item; and
providing, on a display, instructions for routing to the first location, placing the first item in the available space according to the arrangement, routing to the second location, placing the second item in the available space according to the arrangement and routing to the starting location.

20. The system of claim 19, wherein when the sensor detects that at least one of the first item and the second item is no longer in the vehicle, the storage optimization component identifies and stores an intermediate location of the vehicle, the display provides an alert that at least one of the first item and the second item is no longer in the vehicle and the storage optimization component calculates a new route from a current location of the vehicle to the intermediate location and one or more of the first location, second location and starting location based on the arrangement and the optimal route.
